(19) United States
(12) Patent Application Publication
(10) Pub. No.: US 2026/0309953 A1
(43) Pub. Date: Oct. 8, 2026

(54) WHILE-DRILLING FIBER OPTIC COMMUNICATION SYSTEM AND METHOD

(71) Applicant: Wuhan University Of Technology, Wuhan (CN)

(72) Inventors: Lei Liang, Wuhan (CN); Hui Wang, Wuhan (CN); Ke Jiang, Wuhan (CN); Shu Dai, Wuhan (CN); Jiahui Zhang, Wuhan (CN)

(21) Appl. No.: 19/393,530

(22) Filed: Nov. 18, 2025

Related U.S. Application Data
(63) Continuation of application No. PCT/CN2025/130805, filed on Oct. 29, 2025.

(30) Foreign Application Priority Data
Apr. 7, 2025 (CN) 2025104238604

(51) Int. Cl. G02B 6/44; G02B 6/255; G02B 6/50

(52) U.S. Cl. CPC G02B 6/4458; G02B 6/2553; G02B 6/443; G02B 6/4441; G02B 6/504

(57) ABSTRACT

The present application proposes a while-drilling fiber optic communication system and method, and relates to the technical field of drilling engineering. The system includes a wellhead mechanism, a splicing mechanism above, and a releasing mechanism. A splicing drill pipe section of the splicing mechanism is connected to a wellhead drill pipe section, and its cable coiling device retracts and releases a photoelectric composite cable, and a signal passes through a photoelectric slip ring and an optical fiber in a rigid connecting rod, and then is connected to an optical fiber in a coiling box of the releasing mechanism through a wet connector. The releasing mechanism is fixed by an anchoring device to realize while-drilling continuous communication.

The present application claims priority to Chinese patent application No. 2025104238604 filed on Apr. 7, 2025 to the China National Intellectual Property Administration, and entitled “WHILE-DRILLING FIBER OPTIC COMMUNICATION SYSTEM AND METHOD”, the entire content of which is incorporated herein by reference.

### TECHNICAL FIELD

The present application relates to the technical field of drilling engineering, in particular to a while-drilling fiber optic communication system and method.

### BACKGROUND

An oil and gas exploration technology is advancing into complex fields such as low permeability, unconventionality, deep and ultra-deep layers, and deepwater. Drilling engineering is facing major challenges in terms of efficiency, safety, quality, etc., and new drilling methods and technologies are urgently needed. Automated intelligent drilling and completion is the future trend, the key to which lies in downhole measurement, transmission and automatic control. This involves real-time downhole sensing, parameter measurement and transmission, and two-way high-speed communication between a well and the ground, which are the core conditions for realizing digital twin and while-drilling visual drilling, supporting decision-making and analysis of drilling parameter optimization, risk prediction, trajectory guidance and control, etc., improving drilling efficiency, and reducing complex timeliness. A traditional measurement while drilling device is slow in communication speed, making it difficult to realize real-time and efficient sensing, and it has become a research hotspot to improve the real-time sensing rate.

In the process of drilling and mining, commonly used communication while drilling devices can be divided into two categories: wired transmission and wireless transmission. According to the research results at home and abroad, wired transmission is mostly based on a logging cable transmission principle. A cable transmission mode is one of the most widely used technologies in logging activities, using a multicore cable as a transmission medium, placing the multicore cable inside a drill pipe using an embedding method, and building a transmission link after connecting sections of the drill pipe, and realizing the two-way communication of signals. However, the cable transmission mode has problems such as slow transmission rate, occupying large space inside the drill pipe, and being susceptible to electromagnetic interference, resulting in the reliability and efficiency of signal transmission being limited.

Wireless transmission modes such as acoustic wave transmission, electromagnetic transmission and mud transmission, although solving some problems of cable transmission to a certain extent, have shortcomings such as small amount of information transmission, large signal attenuation, and poor anti-interference ability, which cannot meet the demand for real-time and efficient communication in a complex drilling environment.

A while-drilling fiber optic communication technology is an advanced communication technology used in the oil and gas industry. Based on the advantages in the field of fiber optic communication, fiber optic communication is suitable for high-speed and broadband information transmission because of its large capacity, wide bandwidth, low loss, strong anti-interference, good confidentiality performance and other characteristics. Optical fibers are made from abundant and environmentally friendly raw materials and have a long service life. The while-drilling fiber optic communication technology has the advantages such as high bandwidth, strong anti-interference, resistance to corrosion, high temperature and high pressure, and real-time performance, thus greatly improving the real-time monitoring of well bottom conditions and data transmission rate in the exploitation while drilling process of oil and natural gas wells.

However, through practical application and experimental research, it is found that during the splicing process of drill pipe drilling, it is difficult to realize the upper and lower butt joint of optical fibers inside an original drill pipe and a splicing drill pipe by the while-drilling fiber optic communication device of the related art. Moreover, with the increasing depth of drilling, the while-drilling fiber optic communication device needs to store several kilometers of optical fibers for the upward transmission of downhole measurement signals. In addition, the optical fiber inside the drill pipe needs to continuously endure scouring of downhole mud and the intense vibration environment during a drilling process, which makes it difficult to ensure the reliability of the optical fiber. These factors directly affect the reception of downhole measurement signals at a ground information processing terminal. Therefore, how to realize the smooth lowering of the optical fiber and ensure normal communication in the process of drill pipe splicing is an important technical challenge faced by the current while-drilling fiber optic communication technology.

### SUMMARY

In view of this, the present application proposes a while-drilling fiber optic communication system and method, to solve the problem of realizing smooth lowering of an optical fiber and ensuring normal communication during a splicing process of a drill pipe.

A technical solution of the present application is realized in this way.

In a first aspect, the present application provides a while-drilling fiber optic communication system, including:

a wellhead mechanism, comprising a wellhead drill floor and a wellhead drill pipe section, wherein the wellhead drill pipe section is installed on the wellhead drill floor;

a splicing mechanism, located above the wellhead mechanism, and capable of moving up and down relative to the wellhead mechanism, wherein the splicing mechanism comprises a fixing frame, a drive rod, a splicing drill pipe section, a cable coiling device, a photoelectric slip ring, and a rigid connecting rod, the drive rod is vertically disposed on the fixing frame and is capable of rotating relative to the fixing frame, an upper end of the splicing drill pipe section is detachably connected to the drive rod, a lower end of the splicing drill pipe section is detachably connected to the wellhead drill pipe section, the cable coiling device is disposed on the fixing frame for retracting and releasing a photoelectric composite cable, a first optical fiber is disposed in the rigid connecting rod, a first wet connector is disposed at a lower end of the rigid connecting rod, an upper end of the rigid connecting rod is mechanically connected to the photoelectric slip ring, one end of the first optical fiber is optically coupled with the photoelectric slip ring, the other end of the first optical fiber is connected to the first wet connector, and the rigid connecting rod movable penetrates through the drive rod and the splicing drill pipe section; and

a releasing mechanism, comprising a coiling box and an anchoring device, wherein a second optical fiber is coiled on the coiling box, a top of the coiling box has a second wet connector connected to the second optical fiber, the second wet connector is detachably connected to the first wet connector to make the first optical fiber and the second optical fiber establish a communication connection, and the anchoring device is disposed on the coiling box and is configured to be anchored to the splicing drill pipe section.

In some embodiments, the photoelectric composite cable includes a protective jacket and at least one transmission optical fiber encapsulated therein, the protective jacket integrates a mechanically reinforced structure, and a carrying capacity of the photoelectric composite cable is configured to be greater than a maximum total load generated by the photoelectric slip ring, the rigid connecting rod, and the releasing mechanism during a downhole operation.

In some embodiments, the photoelectric composite cable further includes at least one power transmission cable encapsulated in the protective jacket, a first cable is disposed in the rigid connecting rod, an upper end of the first cable is electrically connected to the power transmission cable through the photoelectric slip ring, a lower end of the first cable is connected to a conductive contact of the first wet connector, a second cable is disposed in the coiling box, one end of the second cable is connected to a conductive contact of the second wet connector, and the other end of the second cable is connected to the anchoring device.

In some embodiments, the anchoring device includes an electric drive mechanism, a force transmission assembly, and an anchoring execution assembly which is capable of expanding radially, and the electric drive mechanism receives electrical energy through the second cable and drives the force transmission assembly to convert a rotational movement into linear displacement, thus forcing the anchoring execution assembly to expand radially and to form mechanical lock with an inner wall of a drill pipe section.

In some embodiments, a peripheral wall of the coiling box is provided with a winding groove of a helical structure in an axial direction thereof, and the second optical fiber is wound in the winding groove.

In some embodiments, the releasing mechanism further includes a releasing frame, the releasing frame is coaxially and fixedly disposed at a bottom of the coiling box, the anchoring device is disposed on the releasing frame, a plurality of guide wheel groups are disposed on an outer side of the releasing frame, the plurality of guide wheel groups are arranged at helical intervals in an axial direction of the releasing frame, each guide wheel group comprises two relatively rotating guide wheels, rotation axes of the guide wheels are perpendicular to an axis of the coiling box, and a guide gap for the second optical fiber to pass through is formed between the two guide wheels.

In some embodiments, the releasing mechanism further includes a damper, and the damper is fixedly connected to a release end of the second optical fiber.

In some embodiments, the cable coiling device includes a cable coiling shaft and a power source, the cable coiling shaft is rotationally disposed on a top of the fixing frame, the photoelectric composite cable is coiled on the cable coiling shaft, one end of the photoelectric composite cable is configured to be connected to data acquisition equipment, the other end of the photoelectric composite cable is connected to the photoelectric slip ring, and the power source is configured to drive the cable coiling shaft to rotate forwards or backwards.

In some embodiments, the wellhead mechanism further includes a locking device, the locking device is disposed on the wellhead drill floor and is configured to fix the wellhead drill pipe section to the wellhead drill floor when the drill pipe section is spliced and to allow the wellhead drill pipe section to slide along the wellhead drill floor during drilling, the releasing mechanism further includes a support member, and the support member is detachably disposed on the second wet connector, and is configured to temporarily fix the coiling box to an outlet end of the wellhead drill pipe section when the drill pipe section is spliced.

In a second aspect, the present application provides a while-drilling fiber optic communication method, utilizing the while-drilling fiber optic communication system described in the first aspect, including steps as follows:

S1. fixing a wellhead drill pipe section on a wellhead drill floor, and placing a releasing mechanism in the wellhead drill pipe section, so that a coiling box is fixed at an outlet end of the wellhead drill pipe section;

S2. lifting a splicing mechanism to a certain height, and connecting an upper end of a splicing drill pipe section to a lower end of a drive rod;

S3. releasing a photoelectric composite cable, so that a first wet connector passes through the splicing drill pipe section and is connected to a second wet connector, thus establishing an optical path connection between a first optical fiber and a second optical fiber;

S4. canceling fixation of the coiling box in the wellhead drill pipe section, retracting the photoelectric composite cable, lifting the coiling box into the splicing drill pipe section, and anchoring the coiling box to an inner wall of the splicing drill pipe section through an anchoring device;

S5. lowering the splicing mechanism, connecting a lower end of the splicing drill pipe section to the wellhead drill pipe section, and relieving fixation of the wellhead drill pipe section on the wellhead drill floor;

S6. driving the drill pipe to rotate and descend for drilling;

S7. stopping drilling after the splicing drill pipe section enters a wellbore, disconnecting the upper end of the splicing drill pipe section from the lower end of the drive rod so that the splicing drill pipe section is fixed to the wellhead drill floor, relieving anchoring between the coiling box and the inner wall of the splicing drill pipe section, lifting the coiling box to an outlet end of the splicing drill pipe section, and fixing the coiling box to the outlet end of the splicing drill pipe section, and disconnecting the first wet connector from the second wet connector; and

S8. lifting the splicing mechanism to a certain height, connecting an upper end of a new splicing drill pipe section to the lower end of the drive rod, and repeating steps S3-S7 to complete continuous splicing of a drill pipe.

### BRIEF DESCRIPTION OF DRAWINGS

FIG. 1 is a schematic structural diagram of a while-drilling fiber optic communication system disclosed in the present application;

FIG. 2 is a schematic structural diagram of a rigid connecting rod disclosed in the present application;

FIG. 3 is a schematic diagram of a connection of a photoelectric composite cable, a photoelectric slip ring, and a rigid connecting rod disclosed in the present application;

FIG. 4 is a schematic diagram of a planar structure of a releasing mechanism disclosed in the present application;

FIG. 5 is a schematic diagram of a planar structure of an anchoring device disclosed in the present application;

FIG. 6 is a schematic diagram of a state after assembly of a splicing drill pipe section and a drive rod disclosed in the present application;

FIG. 7 is a schematic diagram of a connection state of a first wet connector and a second wet connector disclosed in the present application;

FIG. 8 is a schematic diagram of a state where a coiling box is lifted to a splicing drill pipe section disclosed in the present application; and

FIG. 9 is a schematic diagram of a drilling state after assembly of a splicing drill pipe section and a wellhead drill pipe section disclosed in the present application.

### DETAILED DESCRIPTION

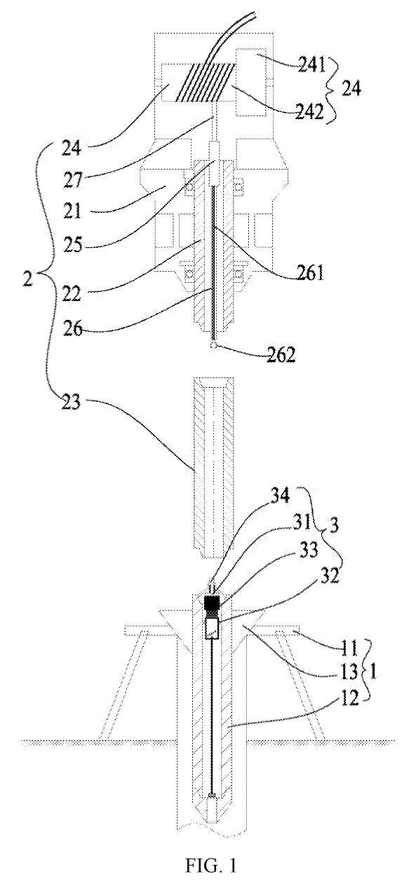

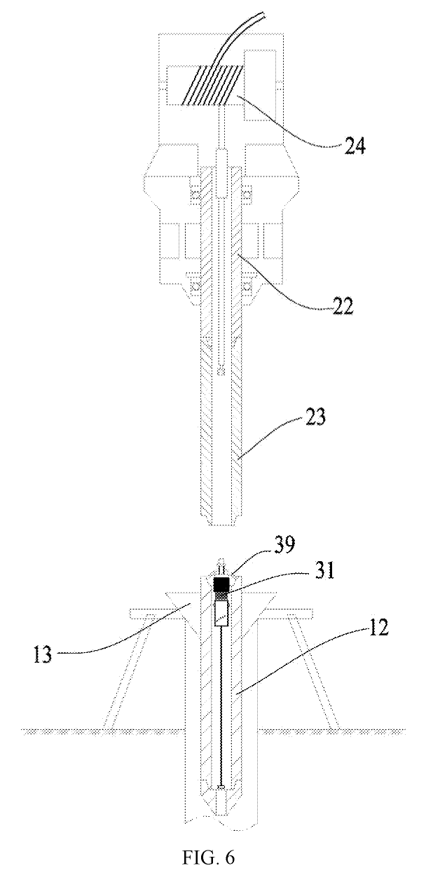

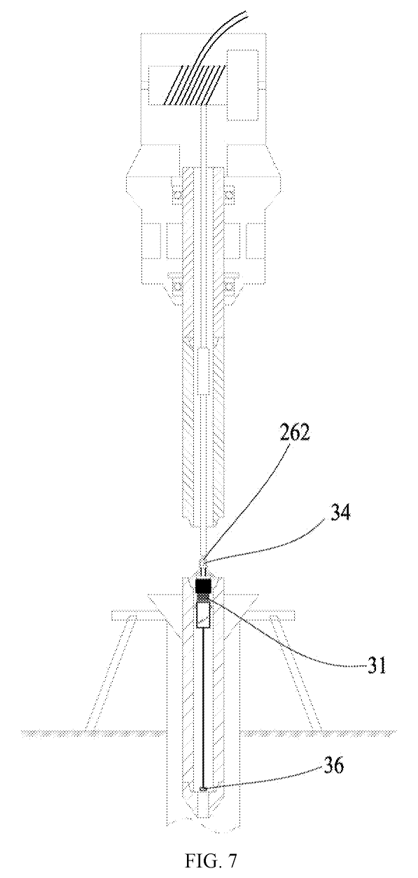

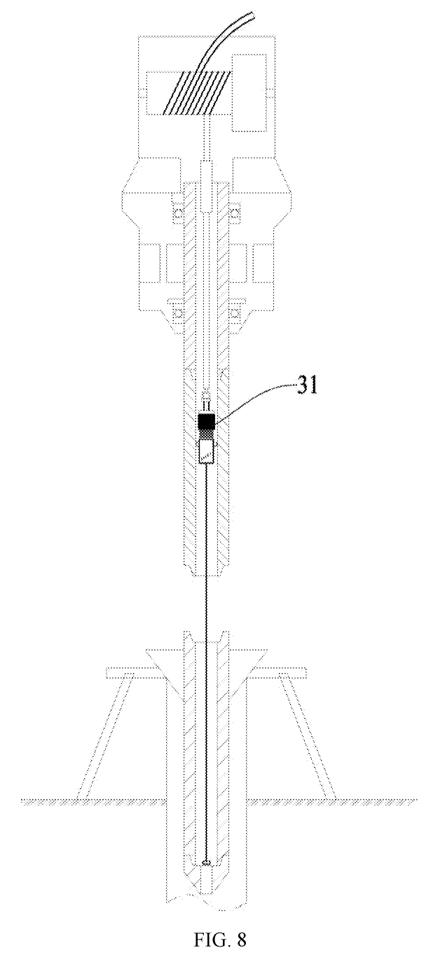

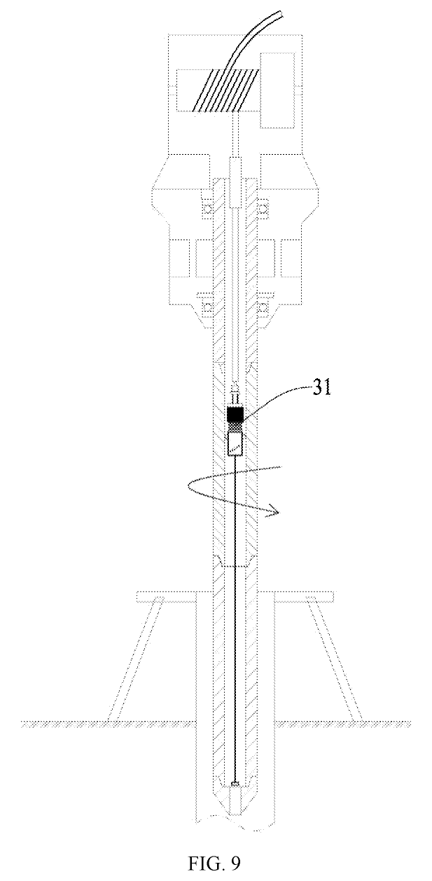

As shown in FIG. 1, in conjunction with FIGS. 6-9, an embodiment of the present application discloses a while-drilling fiber optic communication system, including a wellhead mechanism 1, a splicing mechanism 2, and a releasing mechanism 3.

The wellhead mechanism 1 includes a wellhead drill floor 11 and a wellhead drill pipe section 12. The wellhead drill floor 11 serves as a base platform for drilling and carries the wellhead drill pipe section 12 and other upper equipment to ensure the stability and safety of an entire drilling operation. The wellhead drill pipe section 12 is installed on the wellhead drill floor 11 and serves as a starting connection part of a drill pipe, providing the initial support and connection point of the drill pipe, enabling the while-drilling operation to be performed smoothly from a wellhead.

The splicing mechanism 2 is located above the wellhead mechanism 1, and is capable of moving up and down relative to the wellhead mechanism 1. This arrangement provides a flexible operating space during a drill pipe splicing process and ensures a smooth splicing operation.

As some implementations, the splicing mechanism 2 may be driven to move up and down by a lifting mechanism, such as a winch or an electric hoist.

The splicing mechanism 2 of this embodiment includes a fixing frame 21, a drive rod 22, a splicing drill pipe section 23, and a cable coiling device 24.

The fixing frame 21 serves as a support structure for the splicing mechanism 2, providing a stable platform for fixing other assemblies and ensuring the stability and reliability of the entire splicing process.

The drive rod 22 is vertically disposed on the fixing frame 21 and is capable of rotating relative to the fixing frame 21. In this embodiment, the drive rod 22 is of a hollow structure, and a lower part of the drive rod 22 has an interface connected to the splicing drill pipe section 23, which facilitates realizing the detachable connection between the upper end of the splicing drill pipe section 23 and the lower end of the drive rod 22. At the same time, the lower end of the splicing drill pipe section 23 is detachably connected to the wellhead drill pipe section 12.

As some implementations, the upper end of the splicing drill pipe section 23 and the lower end of the drive rod 22 may utilize a male/female button threaded connection, a clamp-type quick release connection, or a connection in a wet connector mode. Accordingly, the lower end of the splicing drill pipe section 23 is connected in the same mode as the wellhead drill pipe section 12. The rotation of the drive rod 22 on the fixing frame 21 can be realized through a gear motor matched with a gear transmission mode, or the gear motor matched with a sprocket chain or pulley transmission mode, and the rotation of the drive rod 22 can realize the rotary drilling operation by the drill pipe after the splicing.

The cable coiling device 24 is disposed on the fixing frame 21 for retracting and releasing the photoelectric composite cable 27. Although the photoelectric composite cable 27 can be released in the drill pipe, the photoelectric composite cable 27 cannot be continuously lowered along with the drill pipe when the drill pipe needs splicing.

To this end, this embodiment is realized using the following technical solution.

Specifically, the splicing mechanism 2 of this embodiment is also provided with a photoelectric slip ring 25 and a rigid connecting rod 26, while the releasing mechanism 3 is utilized in cooperation for releasing the optical fiber.

In this embodiment, a first optical fiber 261 is disposed in the rigid connecting rod 26, a first wet connector 262 is disposed at a lower end of the rigid connecting rod 26, an upper end of the rigid connecting rod 26 is mechanically connected to the photoelectric slip ring 25, one end of the first optical fiber 261 is optically coupled with the photoelectric slip ring 25, the other end of the first optical fiber is connected to the first wet connector 262, and the rigid connecting rod 26 movable penetrates through the drive rod 22 and the splicing drill pipe section 23.

The releasing mechanism 3 includes a coiling box 31 and an anchoring device 32. A second optical fiber 33 is coiled on the coiling box 31, a top of the coiling box 31 has a second wet connector 34 connected to the second optical fiber 33, the second wet connector 34 is detachably connected to the first wet connector 262 to make the first optical fiber 261 and the second optical fiber 33 establish a communication connection, and the anchoring device 32 is disposed on the coiling box 31 and is configured to be anchored to the splicing drill pipe section 23.

Thus provided, the cable coiling device 24 can retract and release the photoelectric composite cable 27, and the rigid connecting rod 26 and the photoelectric slip ring 25 rise or fall with the retraction and release of the photoelectric composite cable 27. During initial splicing, the releasing mechanism 3 is placed inside the wellhead drill pipe section 12, and it is ensured that the coiling box 31 can be fixed to an upper open end of the wellhead drill pipe section 12, to ensure that the second wet connector 34 is leaked out of the wellhead drill pipe section 12. When the connection between the upper end of the splicing drill pipe section 23 and the lower end of the drive rod 22 is completed, the photoelectric composite cable 27 is released. At this time, the rigid connecting rod 26 passes through the drive rod 22 and the splicing drill pipe section 23. During a continuous release process, the first wet connector 262 at the lower end of the rigid connecting rod 26 rod and the second wet connector 34 at the top of the coiling box 31 are connected, at which time a connection is established between the second optical fiber 33 on the coiling box 31 and the first optical fiber 261 inside the rigid connecting rod, so that a communication connection is established between the second optical fiber 33, the first optical fiber 261, the photoelectric slip ring 25, and the photoelectric composite cable 27.

Upon completion of the connection of the first wet connector 262 and the second wet connector 34, the fixing of the coiling box 31 in the wellhead drill pipe section 12 is canceled, the photoelectric composite cable 27 is retracted, the coiling box 31 is lifted into the splicing drill pipe section 23 and is anchored to the inner wall of the splicing drill pipe section 23 by the anchoring device 32, the splicing mechanism 2 is moved downwardly, the lower end of the splicing drill pipe section 23 is connected to the wellhead drill pipe section 12, and the fixation of the wellhead drill pipe section 12 on the wellhead drill floor 11 is relieved. At this time, the drive rod 22, the splicing drill pipe section 23 and the wellhead drill pipe section 12 form a drill pipe structure, and the entire drill pipe structure is driven to rotate by the rotation of the drive rod 22. At the same time, the splicing mechanism 2 is lowered to realize the drilling operation, and the coiling box 31 is now anchored to the inner wall of the splicing drill pipe section 23, and can synchronously rotate with the drill pipe and move downward. During the process of synchronous lowering and rotation of the coiling box 31 with the drill pipe, the second optical fiber 33 is gradually released. Due to the role of the photoelectric slip ring 25, the coiling box 31 drives the rigid connecting rod to rotate relative to the photoelectric slip ring 25 in the process of rotation, to ensure that the second optical fiber 33 always maintains the transmission of optical signals in the release process, and to ensure that the normal fiber optic communication in the process of rotary drilling after the drill pipe splicing is completed.

Drilling is stopped after the splicing drill pipe section 23 enters a wellbore, the upper end of the splicing drill pipe section 23 is disconnected from the lower end of the drive rod 22 so that the splicing drill pipe section 23 is fixed to the wellhead drill floor 11, anchoring between the coiling box 31 and the inner wall of the splicing drill pipe section 23 is relieved, the coiling box 31 is lifted to an outlet end of the splicing drill pipe section 23, the coiling box 31 is fixed to the outlet end of the splicing drill pipe section 23, and the first wet connector 262 is disconnected from the second wet connector 34, returning the entire process to before initial construction. The splicing mechanism is lifted to a certain height, a new splicing drill pipe section 23 is reconnected, then the connection of the first wet connector 262 and the second wet connector 34 is completed, and then it is possible to continue to realize the establishment of a communication connection between the second optical fiber 33, the first optical fiber 261, and the photoelectric composite cable 27 after the new drill pipe section is spliced, thereby ensuring that fiber optic communication is performed normally in the drilling process after the completion of the drill pipe splicing in the drilling process.

The present application constructs a three-stage fiber optic transmission path of “photoelectric composite cable 27-rigid connecting rod 26-coiling box 31” by disposing the splicing mechanism 2 containing the photoelectric slip ring 25 and the rigid connecting rod 26, and cooperating with the releasing mechanism 3 having the detachable wet connector, wherein the rigid connecting rod 26 movably penetrates through the drive rod 22 and the splicing drill pipe section 23 to realize physical penetration, the photoelectric slip ring 25 guarantees the continuous transmission of the optical signals in the rotating state, and the wet connector structure ensures accurate connection during splicing, so that the establishment of an optical fiber channel and maintenance of a communication link can be completed synchronously during the splicing process of the drill pipe, which solves the problems of interruption of optical fiber lowering and communication failure due to splicing of the drill pipe in the traditional solution, and realizes the continuity and reliability of fiber optic communication in the rotary drilling working condition.

As the photoelectric composite cable 27 needs to lift and pull the releasing mechanism 3, in order to ensure the mechanical strength of the photoelectric composite cable 27 and to avoid the photoelectric composite cable 27 from being pulled off, this embodiment makes a structural arrangement for the photoelectric composite cable 27. The photoelectric composite cable 27 includes a protective jacket 271 and at least one transmission optical fiber 272 encapsulated therein, and by encapsulating the transmission optical fiber 272 in the protective jacket 271, the physical protection of the optical fiber is ensured while maintaining the quality of the optical signal transmission. The protective jacket 271 integrates a mechanically reinforced structure, such as aramid fiber layer+steel wire armoring, so that the composite cable has dual functions of signal transmission and mechanical carrying at the same time.

A carrying capacity of the photoelectric composite cable 27 of this embodiment is configured to be greater than a maximum total load generated by the photoelectric slip ring 25, the rigid connecting rod 26, and the releasing mechanism 3 during a downhole operation. Thus provided, the photoelectric composite cable 27 can have a strong carrying capacity while ensuring stable transmission of fiber optic signals when the releasing mechanism 3 is lifted.

In this embodiment, the reason for lifting the coiling box 31 into the splicing drill pipe section 23 through the photoelectric composite cable 27 and anchoring the coiling box to the inner wall of the splicing drill pipe section 23 through the anchoring device 32 is, on the one hand, to ensure that the coiling box 31 and the drill pipe rotate synchronously and are lowered, and on the other hand, when the lower end of the drive rod 22 is adjacent to the splicing drill pipe section 23 and drills down into the wellbore, the coiling box 31 is just on the upper part of the splicing drill pipe section 23, which is convenient to re-lift the coiling box 31 directly into the new splicing drill pipe section 23 after the connection of the new splicing drill pipe section 23, with a small lifting and displacing stroke of the coiling box 31 and high efficiency.

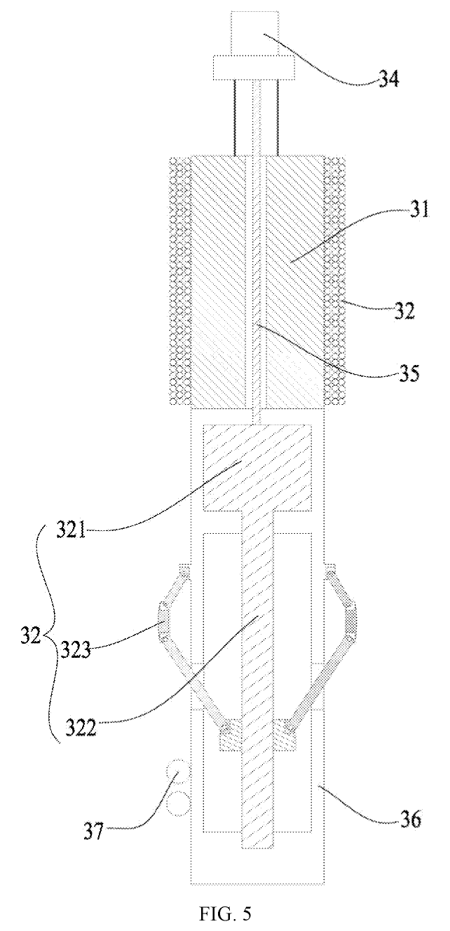

In order to enable the coiling box 31 to be anchored in the splicing drill pipe section 23, this embodiment adopts the mode of setting the anchoring device 32 to be electrically driven, which is due to the fact that it is difficult to realize by other purely mechanical modes. Specifically, as shown with reference to FIG. 5, the anchoring device 32 of this embodiment includes an electric drive mechanism 321, a force transmission assembly 322, and an anchoring execution assembly 323 which is capable of expanding radially, and the electric drive mechanism 321 drives the force transmission assembly 322 to convert a rotational movement into linear displacement, thus forcing the anchoring execution assembly 323 to expand radially and to form mechanical lock with an inner wall of a drill pipe section.

As some implementations, the electric drive mechanism 321 is a direct current servomotor, the force transmission assembly 322 includes a screw-nut pair and a linkage mechanism, and the anchoring execution assembly 323 is a circumferentially distributed umbrella-shaped anchor jaw. When the direct current servomotor is energized, it drives a screw to rotate and drives a nut to move linearly, and converts the axial displacement into the radial expansion movement of the umbrella-shaped anchor jaw through the linkage mechanism, so as to anchor the inner wall of the splicing drill pipe section 23.

As another embodiment, the electric drive mechanism 321 is a piezoelectric ceramic motor, the force transmission assembly 322 includes a harmonic reducer and a cam mechanism, and the anchoring execution assembly 323 is an elastically deformable memory alloy ring.

When the piezoelectric ceramic motor is energized, the cam is driven to rotate through the harmonic reducer, causing the memory alloy ring to undergo radial plastic deformation to form an interference fit with the inner wall of the drill pipe section, thereby enabling the coiling box 31 to be anchored to the inner wall of the splicing drill pipe section 23.

In order to realize power supply to the electric drive mechanism 321, this embodiment adopts the following technical solution for realization.

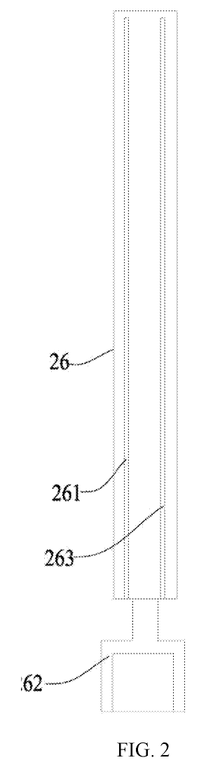

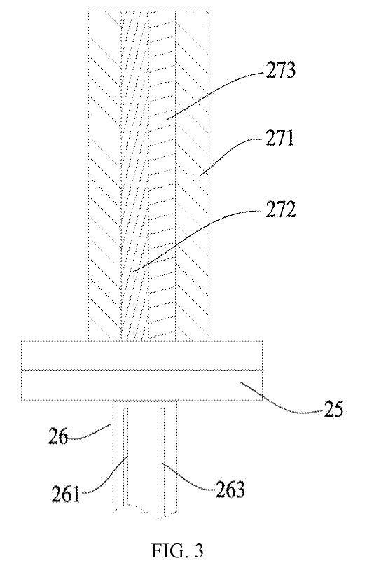

As shown with reference to FIGS. 2 and 3 of the accompanying drawings, the photoelectric composite cable 27 of this embodiment further includes at least one power transmission cable 273 encapsulated in the protective jacket 271, a first cable 263 is disposed in the rigid connecting rod 26, an upper end of the first cable 263 is electrically connected to the power transmission cable 273 through the photoelectric slip ring 25, a lower end of the first cable 263 is connected to a conductive contact of the first wet connector 262, a second cable 35 is disposed in the coiling box 31, one end of the second cable 35 is connected to a conductive contact of the second wet connector 34, and the other end of the second cable is connected to the anchoring device 32.

Thus provided, after the first wet connector 262 and the second wet connector 34 are connected, not only the optical signal connection between the first optical fiber 261 and the second optical fiber 33 is realized, but also the electrical signal connection between the first cable 263 and the second cable 35 can be realized, so that, while the photoelectric composite cable 27 establishes a fiber optic communication connection by the transmission optical fiber 272, the first optical fiber 261 and the second optical fiber 33, it also establishes an electrical connection through the power transmission cable 273, the first cable 263, the second cable 35 and the electric drive mechanism 321 on the anchoring device 32, so as to enable the anchoring device 32 to obtain an electric control capability, and to achieve a high degree of integration and synergistic optimization of the power supply and the communication functions of the while-drilling communication system.

By integrating a power transmission channel in the photoelectric composite cable 27 and synergistically designing it with the rigid connecting rod 26-coiling box 31 cable system, the simultaneous transmission of fiber optic communication and power supply is realized, so that the anchoring device 32 obtains the electric control capability, thus reaching the integrated integration and synergistic optimization of the power supply and the communication functions of the while-drilling communication system.

As some embodiments, the wellhead mechanism 1 further includes a locking device 13, the locking device 13 is disposed on the wellhead drill floor 11 and is configured to fix the wellhead drill pipe section 12 to the wellhead drill floor 11 when the drill pipe section is spliced and to allow the wellhead drill pipe section 12 to slide along the wellhead drill floor 11 during drilling. Specifically, before the splicing of the drill pipe is performed, the wellhead drill pipe section 12 is first fixed on the wellhead drill floor 11 by the locking device 13. When the splicing of the drill pipe is completed, the fixation of the wellhead drill pipe section 12 on the wellhead drill floor 11 is relieved by the locking device 13, so that the splicing mechanism 2 drives the wellhead drill pipe section 12 to rotate downwards and to drill.

As some embodiments, the locking device 13 may be a safety catch, or other clamping mechanism in a mechanical form, as long as it can fix the wellhead drill pipe section 12 to the wellhead drill floor 11 and avoid axial and circumferential displacement of the wellhead drill pipe section 12.

Before the splicing of the splicing drill pipe section 23 is completed, it is necessary to separate the second wet connector 34 from the first wet connector 262, then at this time, the whole releasing mechanism 3 needs to be fixed first to the wellhead drill pipe section 12 or to the splicing drill pipe section 23 which has drilled down into the wellbore. However, since the second wet connector 34 and the first wet connector 262 are separate and the anchoring device 32 is not electrically driven at this time, it is not possible to anchor the coiling box 31 to the inner wall of the drill pipe, and therefore, the present application adopts the following technical solution for realization.

The releasing mechanism 3 further includes a support member 39, and the support member 39 is detachably disposed on the second wet connector 34, and is configured to temporarily fix the coiling box 31 to an outlet end of the wellhead drill pipe section 12 when the drill pipe section is spliced. With such a technical solution, before the initial splicing, the entire releasing mechanism 3 is placed into the wellhead drill pipe section 12 by manually installing the support member 39 on the second wet connector 34, and contact is made between the support member 39 and the upper inner wall of the wellhead drill pipe section 12, so as to play a supporting role and prevent the entire releasing mechanism 3 from falling downward.

During subsequent drill pipe splicing, after the previous splicing drill pipe section 23 drills into the wellbore, at this time, after the drive rod 22 and the current splicing drill pipe section 23 are disconnected, the releasing mechanism 3 is lifted upwardly by the photoelectric composite cable 27, so that the second wet connector 34 on the coiling box 31 leaks out of the current splicing drill pipe section 23, the support member 39 is brought into contact with the interior of the current splicing drill pipe section 23 by manually installing the support member 39 on the second wet connector 34, realizing the temporary fixation of the releasing mechanism 3 on the upper part of the current splicing drill pipe, in this way, it is possible to safely separate the second wet connector 34 from the first wet connector 262, so as to perform the splicing installation of the next splicing drill pipe section 23, when the next splicing drill pipe section 23 completes its connection with the drive rod 22, the second wet connector 34 is connected to the first wet connector 262, and at this point, the support member 39 can be moved out.

In this embodiment, the cable coiling device 24 includes a cable coiling shaft 241 and a power source 242, the cable coiling shaft 241 is rotationally disposed on a top of the fixing frame 21, the photoelectric composite cable 27 is coiled on the cable coiling shaft 241, one end of the photoelectric composite cable 27 is configured to be connected to data acquisition equipment, the other end of the photoelectric composite cable is connected to the photoelectric slip ring 25, and the power source 242 is configured to drive the cable coiling shaft 241 to rotate forwards or backwards. The release and retraction of the photoelectric composite cable 27 can be realized by forward or reverse rotation of the cable coiling shaft 241, and in this embodiment, the power source 242 can be a gear motor.

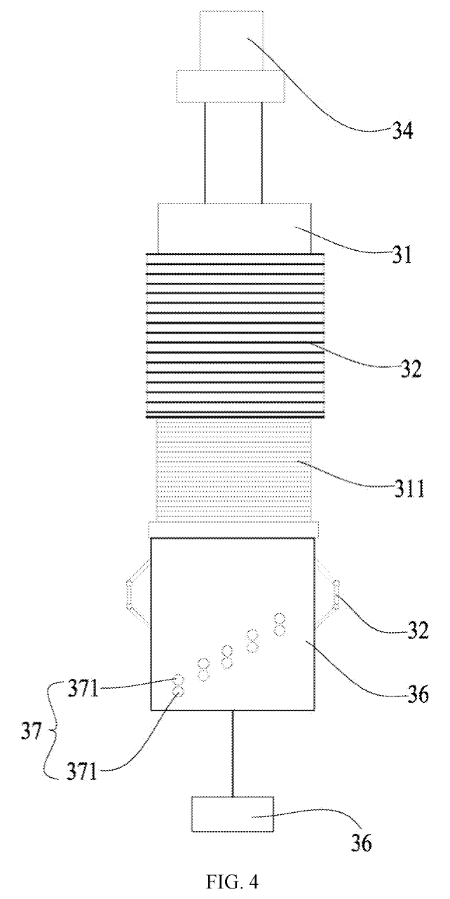

It is noteworthy that, in order to achieve optical fiber implantation downhole during the drilling process, this embodiment winds the second optical fiber 33 on the coiling box 31, so that the second optical fiber is lowered while drilling. In order to avoid tangling of the optical fiber in the releasing process, as shown with reference to FIG. 4, a peripheral wall of the coiling box 31 of this embodiment is provided with a winding groove 311 of a helical structure in an axial direction thereof, and the second optical fiber 33 is wound in the winding groove 311.

The winding groove 311 of the helical structure can guide the optical fiber to be wound and released along a predetermined path, avoiding mutual interlacing and entanglement of the optical fiber during the release process. This design ensures that the optical fiber can be smoothly lowered during the while drilling process, thus effectively avoiding possible entanglement problems during the release process and ensuring the continuity and stability of the optical fiber.

In order to avoid tangling and bending of the optical fiber during the lowering process, the releasing mechanism 3 of this embodiment further includes a damper 38, and the damper 38 is fixedly connected to a release end of the second optical fiber 33. Thus provided, the damper 38 has a certain weight to draw and straighten the second optical fiber 33, avoiding entanglement of the unconstrained release end of the optical fiber.

In order to avoid tangling and knotting of the optical fiber during the release process, the releasing mechanism 3 of this embodiment is also provided with a releasing frame 36, the releasing frame 36 is coaxially and fixedly disposed at a bottom of the coiling box 31, the anchoring device 32 is disposed on the releasing frame 36, a plurality of guide wheel groups 37 are disposed on an outer side of the releasing frame 36, the plurality of guide wheel groups 37 are arranged at helical intervals in an axial direction of the releasing frame 36, each guide wheel group 37 includes two relatively rotating guide wheels 371, rotation axes of the guide wheels 371 are perpendicular to an axis of the coiling box 31, and a guide gap for the second optical fiber 33 to pass through is formed between the two guide wheels 371.

The design of the guide wheel groups 37 is able to effectively reduce the friction of the optical fiber during the release process through the helical arrangement and the optimization of the guide gap. At the same time, the helically spaced plurality of guide wheel groups 37 allow for more precise guidance of the optical fiber and less susceptible to accumulation. When the optical fiber passes through the guide wheel groups 37, the optical fiber is subjected to a more uniform force due to the rotation of the guide wheels 371 and the existence of the guide gaps, which avoids damage to the optical fiber due to excessive friction or unsmooth lowering.

The axis of the guide wheel 371 is perpendicular to the axis of the coiling box 31, which helps the optical fiber to be smoothly lowered along a desired path. Through the continuous action of the plurality of guide wheel groups 37, the optical fiber can be uniformly guided, avoiding bending or entanglement problems that may occur to the optical fiber in the release process, thus improving the stability of lowering of the optical fiber.

This embodiment further discloses a while-drilling fiber optic communication system, comprising steps as follows:

S1. fixing a wellhead drill pipe section 12 on a wellhead drill floor 11, and placing a releasing mechanism 3 in the wellhead drill pipe section 12, so that a coiling box 31 is fixed at an outlet end of the wellhead drill pipe section 12;

S2. lifting a splicing mechanism 2 to a certain height, and connecting an upper end of a splicing drill pipe section 23 to a lower end of a drive rod 22;

S3. releasing a photoelectric composite cable 27, so that a first wet connector 262 passes through the splicing drill pipe section 23 and is connected to a second wet connector 34, thus establishing an optical path connection between a first optical fiber 261 and a second optical fiber 33;

S4. canceling fixation of the coiling box 31 in the wellhead drill pipe section 12, retracting the photoelectric composite cable 27, lifting the coiling box 31 into the splicing drill pipe section 23, and anchoring the coiling box 31 to an inner wall of the splicing drill pipe section 23 through an anchoring device 32;

S5. lowering the splicing mechanism 2, connecting a lower end of the splicing drill pipe section 23 to the wellhead drill pipe section 12, and relieving fixation of the wellhead drill pipe section 12 on the wellhead drill floor 11;

S6. driving the drill pipe to rotate and descend for drilling;

S7. stopping drilling after the splicing drill pipe section 23 enters a wellbore, disconnecting the upper end of the splicing drill pipe section 23 from the lower end of the drive rod 22 so that the splicing drill pipe section 23 is fixed to the wellhead drill floor 11, relieving anchoring between the coiling box 31 and the inner wall of the splicing drill pipe section 23, lifting the coiling box 31 to an outlet end of the splicing drill pipe section 23, and fixing the coiling box 31 to the outlet end of the splicing drill pipe section 23, and disconnecting the first wet connector 262 from the second wet connector 34; and

S8. lifting the splicing mechanism 2 to a certain height, connecting an upper end of a new splicing drill pipe section 23 to the lower end of the drive rod 22, and repeating steps S3-S7 to complete continuous splicing of a drill pipe.

What is claimed is:

1. A while-drilling fiber optic communication system, comprising:
a wellhead mechanism, comprising a wellhead drill floor and a wellhead drill pipe section, wherein the wellhead drill pipe section is installed on the wellhead drill floor;
a splicing mechanism, located above the wellhead mechanism, and capable of moving up and down relative to the wellhead mechanism, wherein the splicing mechanism comprises a fixing frame, a drive rod, a splicing drill pipe section, a cable coiling device, a photoelectric slip ring, and a rigid connecting rod, the drive rod is vertically disposed on the fixing frame and is capable of rotating relative to the fixing frame, an upper end of the splicing drill pipe section is detachably connected to the drive rod, a lower end of the splicing drill pipe section is detachably connected to the wellhead drill pipe section, the cable coiling device is disposed on the fixing frame for retracting and releasing a photoelectric composite cable, a first optical fiber is disposed in the rigid connecting rod, a first wet connector is disposed at a lower end of the rigid connecting rod, an upper end of the rigid connecting rod is mechanically connected to the photoelectric slip ring, one end of the first optical fiber is optically coupled with the photoelectric slip ring, the other end of the first optical fiber is connected to the first wet connector, and the rigid connecting rod movable penetrates through the drive rod and the splicing drill pipe section; and
a releasing mechanism, comprising a coiling box and an anchoring device, wherein a second optical fiber is coiled on the coiling box, a top of the coiling box has a second wet connector connected to the second optical fiber, the second wet connector is detachably connected to the first wet connector to make the first optical fiber and the second optical fiber establish a communication connection, and the anchoring device is disposed on the coiling box and is configured to be anchored to the splicing drill pipe section.

2. The while-drilling fiber optic communication system according to claim 1, wherein the photoelectric composite cable comprises a protective jacket and at least one transmission optical fiber encapsulated therein, the protective jacket integrates a mechanically reinforced structure, and a carrying capacity of the photoelectric composite cable is configured to be greater than a maximum total load generated by the photoelectric slip ring, the rigid connecting rod, and the releasing mechanism during a downhole operation.

3. The while-drilling fiber optic communication system according to claim 2, wherein the photoelectric composite cable further comprises at least one power transmission cable encapsulated in the protective jacket, a first cable is disposed in the rigid connecting rod, an upper end of the first cable is electrically connected to the power transmission cable through the photoelectric slip ring, a lower end of the first cable is connected to a conductive contact of the first wet connector, a second cable is disposed in the coiling box, one end of the second cable is connected to a conductive contact of the second wet connector, and the other end of the second cable is connected to the anchoring device.

4. The while-drilling fiber optic communication system according to claim 3, wherein the anchoring device comprises an electric drive mechanism, a force transmission assembly, and an anchoring execution assembly which is capable of expanding radially, and the electric drive mechanism receives electrical energy through the second cable and drives the force transmission assembly to convert a rotational movement into linear displacement, thus forcing the anchoring execution assembly to expand radially and to form mechanical lock with an inner wall of a drill pipe section.

5. The while-drilling fiber optic communication system according to claim 1, wherein a peripheral wall of the coiling box is provided with a winding groove of a helical structure in an axial direction thereof, and the second optical fiber is wound in the winding groove.

6. The while-drilling fiber optic communication system according to claim 1, wherein the releasing mechanism further comprises a damper, and the damper is fixedly connected to a release end of the second optical fiber.

7. The while-drilling fiber optic communication system according to claim 6, wherein the releasing mechanism further comprises a releasing frame, the releasing frame is coaxially and fixedly disposed at a bottom of the coiling box, the anchoring device is disposed on the releasing frame, a plurality of guide wheel groups are disposed on an outer side of the releasing frame, the plurality of guide wheel groups are arranged at helical intervals in an axial direction of the releasing frame, each guide wheel group comprises two relatively rotating guide wheels, rotation axes of the guide wheels are perpendicular to an axis of the coiling box, and a guide gap for the second optical fiber to pass through is formed between the two guide wheels.

8. The while-drilling fiber optic communication system according to claim 1, wherein the cable coiling device comprises a cable coiling shaft and a power source, the cable coiling shaft is rotationally disposed on a top of the fixing frame, the photoelectric composite cable is coiled on the cable coiling shaft, one end of the photoelectric composite cable is configured to be connected to data acquisition equipment, the other end of the photoelectric composite cable is connected to the photoelectric slip ring, and the power source is configured to drive the cable coiling shaft to rotate forwards or backwards.

9. The while-drilling fiber optic communication system according to claim 1, wherein the wellhead mechanism further comprises a locking device, the locking device is disposed on the wellhead drill floor and is configured to fix the wellhead drill pipe section to the wellhead drill floor when the drill pipe section is spliced and to allow the wellhead drill pipe section to slide along the wellhead drill floor during drilling, the releasing mechanism further comprises a support member, and the support member is detachably disposed on the second wet connector, and is configured to temporarily fix the coiling box to an outlet end of the wellhead drill pipe section when the drill pipe section is spliced.

10. A while-drilling fiber optic communication method, utilizing the while-drilling fiber optic communication system according to claim 1, comprising steps as follows:
S1, fixing a wellhead drill pipe section on a wellhead drill floor, and placing a releasing mechanism in the wellhead drill pipe section, so that a coiling box is fixed at an outlet end of the wellhead drill pipe section;
S2, lifting a splicing mechanism to a certain height, and connecting an upper end of a splicing drill pipe section to a lower end of a drive rod;
S3, releasing a photoelectric composite cable, so that a first wet connector passes through the splicing drill pipe section and is connected to a second wet connector, thus establishing an optical path connection between a first optical fiber and a second optical fiber;
S4, canceling fixation of the coiling box in the wellhead drill pipe section, retracting the photoelectric composite cable, lifting the coiling box into the splicing drill pipe section, and anchoring the coiling box to an inner wall of the splicing drill pipe section through an anchoring device;
S5, lowering the splicing mechanism, connecting a lower end of the splicing drill pipe section to the wellhead drill pipe section, and relieving fixation of the wellhead drill pipe section on the wellhead drill floor;
S6, driving the drill pipe to rotate and descend for drilling;
S7, stopping drilling after the splicing drill pipe section enters a wellbore, disconnecting the upper end of the splicing drill pipe section from the lower end of the drive rod so that the splicing drill pipe section is fixed to the wellhead drill floor, relieving anchoring between the coiling box and the inner wall of the splicing drill pipe section, lifting the coiling box to an outlet end of the splicing drill pipe section, and fixing the coiling box to the outlet end of the splicing drill pipe section, and disconnecting the first wet connector from the second wet connector; and
S8, lifting the splicing mechanism to a certain height, connecting an upper end of a new splicing drill pipe section to the lower end of the drive rod, and repeating steps S3-S7 to complete continuous splicing of a drill pipe.
